(19) United States
(12) Patent Application Publication
(10) Pub. No.: US 2008/0315647 A1
(43) Pub. Date: Dec. 25, 2008

(54) Base for a Child Safety Seat

(75) Inventor: David Shaun Carine, Hampshire (GB)

Correspondence Address: ADAMS INTELLECTUAL PROPERTY LAW, P.A., Suite 2350 Charlotte Plaza, 201 South College Street, CHARLOTTE, NC, 28244, US

(73) Assignee: BRITAX EXCELSIOR LIMITED, Hampshire (UK)

(21) Appl. No.: 11/570,648

(22) PCT Filed: Jun. 6, 2005
(86) PCT No.: PCT/GB05/02238

§ 371 Date: Oct. 29, 2007

(30) Foreign Application Priority Data
Jun. 19, 2004 (GB) 04113940.8

(51) Int. Cl. B60N 2/28

(52) U.S. Cl. 297/250.1

(57) ABSTRACT

A base for a child safety seat adapted for use with an adult seat in a vehicle which has a substructure adapted for being positioned on the adult seat bottom. A pair of attachments are selected from the group of the adult seat at the seat's junction between the seat back and the seat bottom. A pair of links pivotally connect at respective first ends to the pair of attachments. At the opposing ends, the links connect to elevated link securement points of the child safety seat. A foot prop is attached to the front portion of the base for extending past the front edge of the adult seat bottom. A connecting element between the child safety seat and the substructure permits the child safety seat to move away from the back of the adult seat with a corresponding elevation of the front of the base.

### TECHNICAL FIELD AND BACKGROUND OF THE INVENTION

The present invention relates to a base for a child safety seat.

A base for a child safety seat is convenient in allowing a single device fitted to a vehicle, normally a car, to be used for at least two sizes of child seat, such as are necessary as children grow.

For youngest children, i.e. infants, a forwards facing seat is not acceptable. An infant carrier is fitted in the car facing backwards. In some countries, this practice is continued for pre-school age children. In terms of groupings used in the industry, the former are Group 0+ children and the latter are Group 1 children.

In this specification, the term “child safety seat” is intended to include both rearwards facing “infant carriers”, rearwards facing Group 1 children's seats and forwards facing Group 1 childrens' seats at least, all being adapted for accident-secure attachment to a vehicle. It is recognised that an infant carrier is an occupant support in which the infant is in a reclined position, but not a lain-down flat position as in a bed. As such it carries the weight of its occupant's spine along the length of the spine as opposed to a conventional seat, which is an occupant support supporting the hips, with the spine weight being reacted to the hips and thence to the seat bottom, or squab. An infant carrier is not a seat in the normal usage of the word “seat”. However, the term “child safety seat” is a term of the art which includes infant carriers and is used in this specification in this context.

Normally an infant carrier has a carrying handle for use outside a vehicle.

The child safety seats of this invention are adapted for their accident-secure attachment to a vehicle via a base. They may in addition be adapted to be secured in a vehicle via an adult safety belt.

ISOFIX is a system for fixing child safety seats in vehicles. It is established under UNECE Regulation 44.03. Essentially it provides for a pair of steel bars in an adult seat at the junction between the seat back and the seat bottom, the child safety seat being able to be latched onto the bars. The bars can be configured as loops and the possible configurations are referred to generically as ISOFIX points in this specification.

ISOFIX seats can suffer from excessive forwards movement in pivoting about the ISOFIX points if not provided with a top tether, i.e. a tether for the back of the seat acting at its top.

It is known from European Patent Application No. 1,279,554 to provide a seat base to be secured in the adult seat by means of its adult seat belt with a foot prop for supporting the front of the seat base.

Further it is known from European Patent Application No. 1,300,280 to provide a link from an ISOFIX latch—not otherwise securing the seat—to a point on an infant carrier above the center of gravity of the seat and a child in the carrier, with a view to increasing the spine angle of the child in an accident. However, it is now believed that in practice this arrangement can operate with the link and the carrier tending to pivot down as opposed to the carrier pivoting up around the link.

### SUMMARY OF THE INVENTION

Therefore, it is an object of the invention to provide an improved base for a child safety seat.

According to the invention there is provided a base for a child safety seat to be used with an adult seat in a vehicle, the base including a substructure configured for positioning over a squab of an adult seat and a pair of attachments for attaching the rear of the substructure to the adult seat at the junction of the seat's squab and back or to the structure of the vehicle for securement of the rear of the substructure at the said junction. A pair of links is pivotally connected at their one ends to the pair of attachments and/or to the rear of the substructure and at their other ends to elevated link securement points in the child safety seat. A foot prop is attached to the front of the substructure for extending past the front edge of the seat bottom of the adult seat and abutting the floor of the vehicle. A mechanical connection is provided between the child safety seat and the substructure at the front end thereof, the connection allowing the child safety seat to move away from the back of the adult seat, with a concomitant rise of the foot prop end of the child safety seat.

While the pair of attachments can be adult seat belt attachments for the substructure, in the preferred embodiment they are ISOFIX latches for securing the substructure to the ISOFIX points of the adult seat.

The mechanical connection can be a connecting link at each side of the child safety seat and the substructure, pivoted to each, the lower front end being pivoted to the substructure and the upper rear end being pivoted to the child safety seat. The arrangement is such that in an accident the links are restrained at their front ends on the substructure and their rear ends jack up the child safety seat, with a concomitant rise of the foot prop end of the child safety seat.

In the preferred embodiment, the mechanical connection is a simple abutment and is configured as a pair of ramps for lifting the under-surface of the child safety seat as it moves away from the back of the adult seat, a front corner of the under-surface rising up the ramps. However, it is envisaged that a similar effect can be achieved by a cross-bar in the substructure on which the under-surface rests. As the under-surface slides on the crossbar, the distance in the child safety seat from the line of contact with the crossbar to the elevated link securement points increases, causing the foot prop end of the child safety seat to rise up.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a side view of a child-safety-seat base, with a child seat installed, in accordance with the invention,

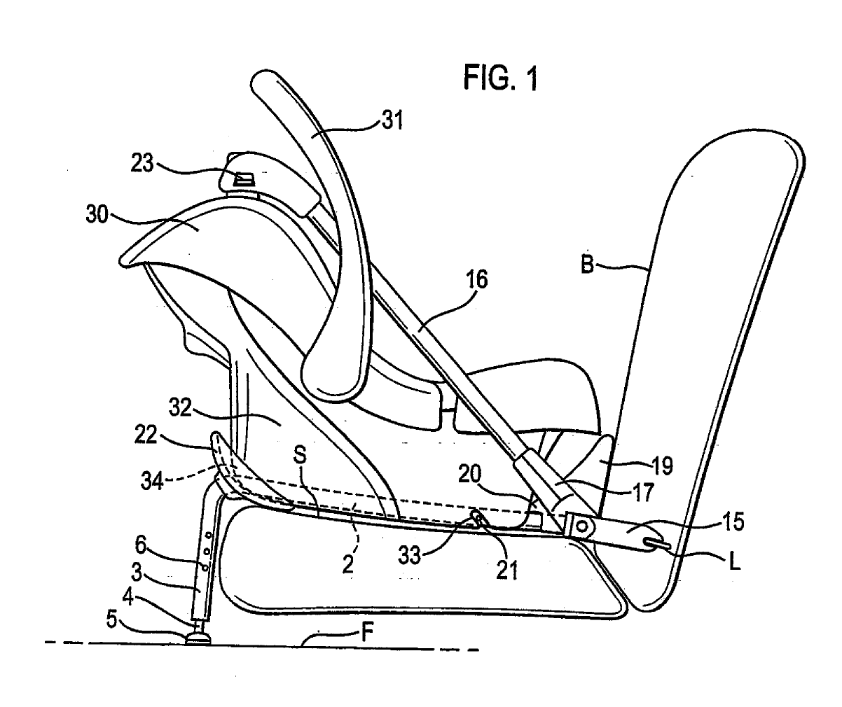

FIG. 2 is a similar view of the base and seat in an accident position and

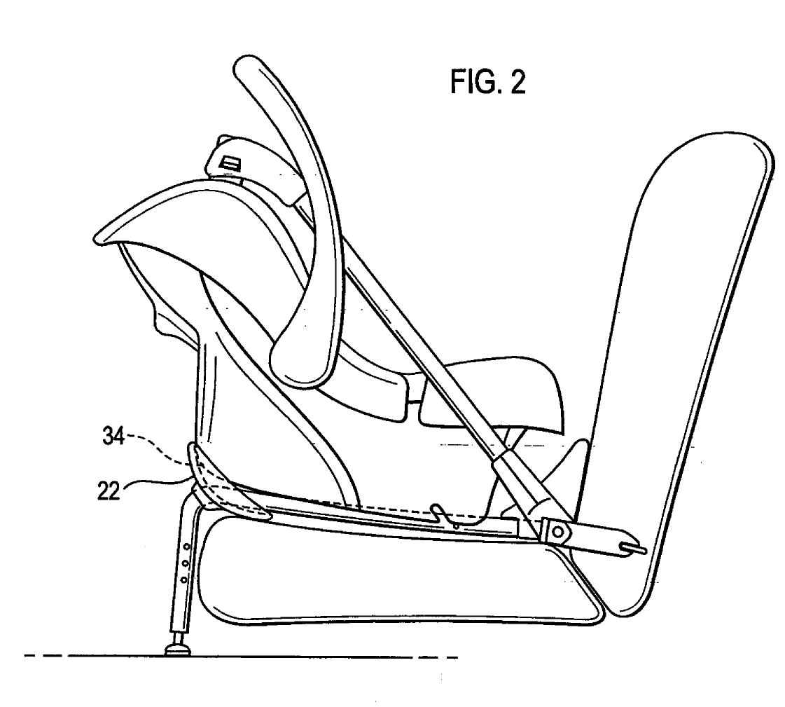

FIG. 3 is a perspective view of the base alone.

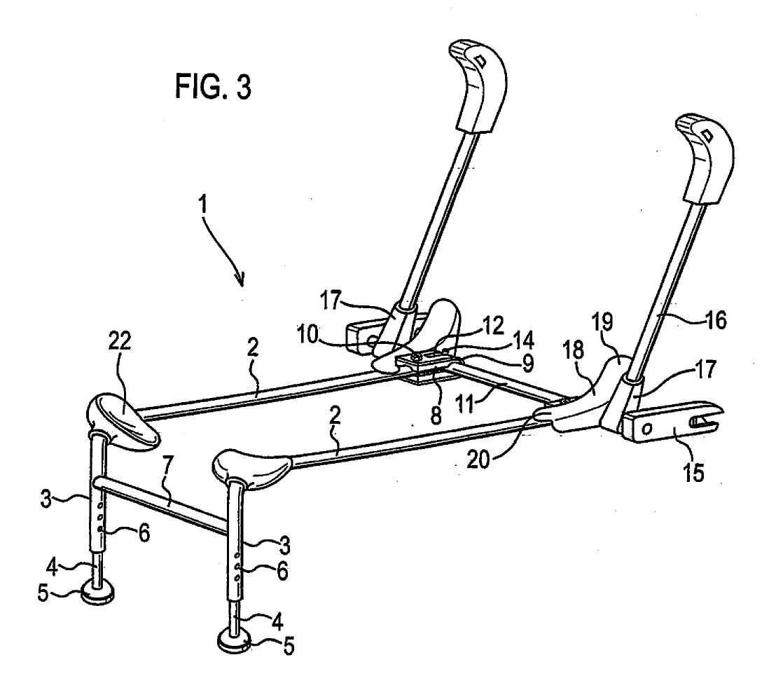

### DESCRIPTION OF THE PREFERRED EMBODIMENT AND BEST MODE

Referring now specifically to the drawings, the child seat base shown therein has a susbstructure 1 comprised of two tubular steel longitudinals 2, turned down at their front end as legs 3. These telescopically carry inner legs 4 with feet 5. Adjustment 6 is provided for the telescopic length of the legs 3,4. At their front end, the legs are spaced by a welded on cross member 7.

At their rear end, the longitudinals 2 carry molded plastics material bearing blocks 8 and straps 9, secured in place by bolts 10. Passing laterally through the bearings is a cross tube 11. The straps have slots 12 and the tube has pressed in roll pins 14, whereby the tube has a half turn of rotary freedom, but no longitudinal freedom, i.e. no freedom laterally of the longitudinals 2. Welded to the ends of the cross tube are inner parts of the ISOFIX latches 15.

Inwards of the ISOFIX latches are carried tubular steel struts 16, via bearings and straps (not shown) similar to those above 8,9, and covered by moldings 17. Inwards of the struts, anti-rebound moldings 18 having one limb 19 bearing against the back B of an adult seat in use and another limb 20 bearing against the top of the longitudinals 2. Thus when the base is latched to the adult seat via its ISOFIX points L, the base cannot rise up under accident rebound conditions. With the base latched on, the legs are adjusted to reach the floor F, with the longitudinals close above the seat squab S.

An infant carrier 30 is engaged on the substructure. The carrier 30 has a handle 31 attached to its sides 32, which continue to the bottom edge of the seat, at which level, there is a downwards open channel between the sides. The longitudinals 2 are received in the channels, with the guide notches 33 receiving pins 21 extending sideways from the longitudinals. At the front, back in the context of a rear facing infant child in the carrier 30, of the sides 32, the corners 34 are received in ramp moldings 22 clamped to the longitudinals 2 at the junction of the latter, the legs 3 and the cross member 7. The ramps are arranged so that in a frontal accident, the corners 34 ride up the ramp surfaces, giving the infant a more vertical orientation. This is desirable in restricting longitudinal acceleration of the infant's spine.

The top of the infant carrier is connected in use to the distal ends of the struts 16 via latches 23. These are the primary securement of the infant carrier to the ISOFIX points and are engineered accordingly. They react inertia of the infant carrier and the infant in a frontal accident, applying deceleration. The inertia acting at the center of gravity, which is between the corners 34 and the latches 23, causes the corners 34 to rise up the ramps, in the process turning the infant to a more upright position.

A base for a child safety seat is described above. Various details of the invention may be changed without departing from its scope. Furthermore, the foregoing description of the preferred embodiment of the invention and the best mode for practicing the invention are provided for the purpose of illustration only and not for the purpose of limitation—the invention being defined by the claims.

1-11. (canceled)

12. A base for a child safety seat adapted for use with an adult seat in a vehicle, the base comprising:
(a) a substructure adapted for being positioned on a seat bottom of the adult seat;
(b) a pair of attachments for attaching the substructure to a support selected from the group consisting of the adult seat at the junction of the seat bottom and a seat back of the adult seat, and the vehicle;
(c) a pair of links pivotally connected at respective first ends to the pair of attachments and at respective second ends to elevated link securement points on the child safety seat;
(d) a foot prop attached to a front of the substructure for extending past a front edge of the adult seat bottom and engaging a floor of the vehicle; and
(e) a connecting element positioned between the child safety seat and the substructure at the front end thereof, the connecting element adapted to permit the child safety seat to move away from the back of the adult seat with a corresponding elevation of the front of the substructure of the base.

13. A base according to claim 12, wherein the attachments comprise adult seat belt elements associated with the adult seat.

14. A base according to claim 12, wherein the connecting element comprises a pair of pivoting connecting links on respective sides of the child safety seat and the substructure.

15. A base according to claim 12, wherein the connecting element comprises a pair of ramps for lifting an undersurface of the child safety seat as it moves away from the back of the adult seat.

16. A base according to claim 12, wherein the connecting element comprises a crossbar positioned in the substructure on which the child safety seat rests.

17. A base according to claim 12, wherein the links comprise tubular struts.

18. A base according to claim 12, wherein the substructure includes two longitudinal elements.

19. A base according to claim 12, wherein the two longitudinal elements have respective turned-down front portions forming leg portions of the foot prop.

20. A base according to claim 19, wherein the leg portions include telescoping inner leg portions.

21. A base as claimed in claim 12, 13, 14, 15, 16, 17, 18, 19, or 20 in combination with a child safety seat.
